(19) United States
(12) Patent Application Publication
(10) Pub. No.: US 2019/0016191 A1
(43) Pub. Date: Jan. 17, 2019

(54) SYSTEMS AND METHODS FOR PORTABLE ASHTRAY WITH FINE DUST SENSOR

(71) Applicant: GM GLOBAL TECHNOLOGY OPERATIONS LLC, Detroit, MI (US)

(72) Inventors: Xiaolin ZHU, Shanghai (CN); Wenshui WANG, Shanghai (CN); Jing ZHANG, Shanghai (CN)

(73) Assignee: GM GLOBAL TECHNOLOGY OPERATIONS LLC, Detroit, MI (US)

(21) Appl. No.: 16/069,340

(22) PCT Filed: Mar. 1, 2016
(86) PCT No.: PCT/CN2016/075145

§ 371 Date: Jul. 11, 2018

(51) Int. Cl. B60H 1/00; B60N 3/08; F24F 11/52; F24F 11/33

(52) U.S. Cl. CPC B60H 1/008; B60N 3/083; F24F 2110/62; F24F 11/33; F24F 11/52

(57) ABSTRACT

Methods and apparatus are provided for determining a particulate concentration level with a portable component. In one embodiment, the method includes outputting one or more control signals, by a processor, to activate a motor to generate an airflow stream through a cavity of the portable component; determining a concentration level of fine particulate matter in the airflow; determining an air quality level of the airstream through the cavity based on the determined concentration level; and outputting the determined concentration level with a graphical indicator of the air quality level for display on a display associated with the portable component.

### CROSS-REFERENCE TO RELATED APPLICATION

This application is a U.S. National-Stage entry under 35 U.S.C. § 371 based on International Application No. PCT/CN2016/075145, filed Mar. 1, 2016, which was published under PCT Article 21(2) and is hereby incorporated in its entirety by reference.

### TECHNICAL FIELD

The present disclosure generally relates to portable components, such as portable ashtrays, and more particularly relates to systems and methods for a portable component, such as an ashtray, having a fine dust sensor.

### BACKGROUND

Air quality may vary across certain environments due to the characteristics of the environment. For example, air quality in a highly populated area may be different than air quality in a rural area. Further, air quality in an industrial area may be different than air quality in an agricultural area. In certain environments, levels of fine dust or particulate matter may be present in air surrounding the user, which may change a quality of the air. The levels of fine dust or particulate matter may vary depending upon the characteristics of the environment. In many instances, users are unaware of the levels of fine dust in an environment due to the generally microscopic size of the fine dust particles.

Accordingly, it is desirable to incorporate a fine dust sensing device into a portable component, such as a portable ashtray, to detect a quantity of the fine dust in the air of an environment surrounding a user. Furthermore, other desirable features and characteristics of the present invention will become apparent from the subsequent detailed description and the appended claims, taken in conjunction with the accompanying drawings and the foregoing technical field and background.

### SUMMARY

In one embodiment, a method is provided for determining a particulate concentration level with a portable component. The method includes outputting one or more control signals, by a processor, to activate a motor to generate an airflow stream through a cavity of the portable component; determining a concentration level of fine particulate matter in the airflow; determining an air quality level of the airstream through the cavity based on the determined concentration level; and outputting the determined concentration level with a graphical indicator of the air quality level for display on a display associated with the portable component.

In one embodiment, a portable component for determining a fine particulate matter concentration level is provided. The portable component includes a housing that defines a cavity. The housing has at least one inlet airflow passage and at least one outlet airflow passage in fluid communication with the cavity. The portable component also includes a source of an airflow through the cavity, and a fine particulate matter sensor that observes the airflow through the cavity and generates sensor signals based thereon. The portable component includes a display coupled to the housing. The portable component also includes a control module that processes the sensor signals and determines the fine particulate matter concentration level, determines an air quality level based on the fine particulate matter concentration level and outputs the fine particulate matter concentration and an indicator of the air quality level for display on the display.

### DESCRIPTION OF THE DRAWINGS

The exemplary embodiments will hereinafter be described in conjunction with the following drawing figures, wherein like numerals denote like elements, and wherein:

FIG. 1 is a schematic illustration of a vehicle that includes a portable component, in this example, a portable ashtray system, in accordance with various embodiments;

FIG. 2 is a perspective view of the portable ashtray system of FIG. 1, with a lid of the ashtray system in a first, closed position;

FIG. 3 is a cross-sectional view of a portion of the housing of the portable ashtray system of FIG. 1, taken along line 3-3 of FIG. 2;

FIG. 4 is a rear view of the portable ashtray system of FIG. 1, with a portion of the housing removed;

FIG. 5 is a schematic perspective view of the portable ashtray system of FIG. 1 positioned within the vehicle, with the lid of the ashtray system in a second, opened position;

FIG. 6 is a functional block diagram of the portable ashtray system of FIG. 1;

FIG. 7 is a dataflow diagram illustrating a control system of the portable ashtray system of FIG. 1 in accordance with various embodiments; and

FIG. 8 is a flowchart illustrating a control method of the portable ashtray system of FIG. 1 in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the ashtray system described herein is merely one exemplary embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

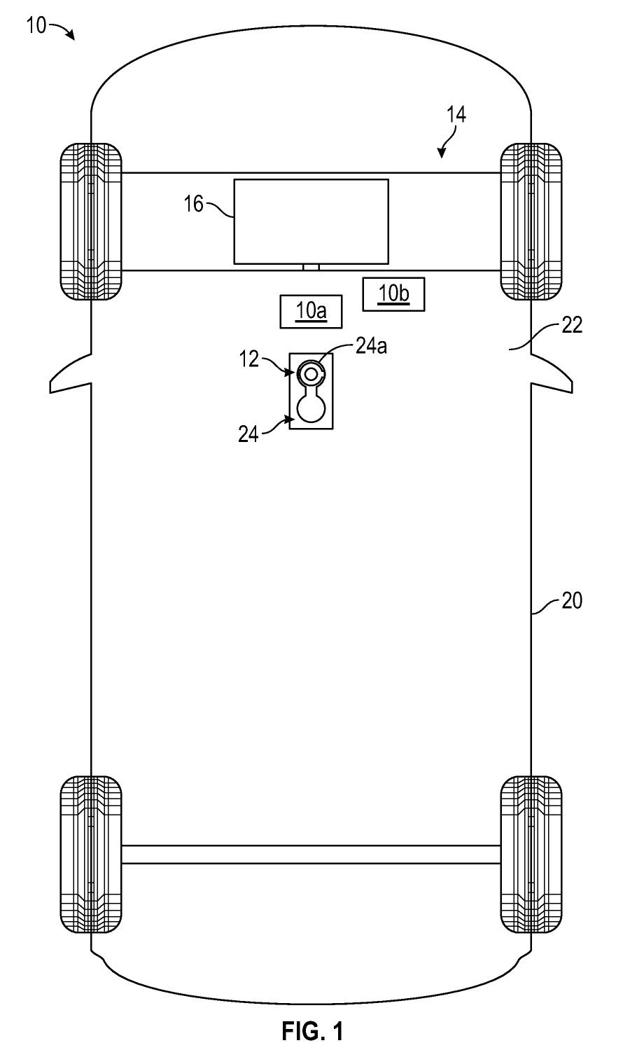

With reference to FIG. 1, one example of a vehicle 10 having a portable component, such as a portable ashtray system 12, is shown. It will be understood that while the portable component is described and illustrated herein as comprising an ashtray or ashtray system, the teachings of the present disclosure are not so limited. In this regard, the portable component can comprise a portable container, which can hold any desired object, and thus, the portable component of the present disclosure is not limited to an ashtray comprising an ash receptacle. Moreover, it should be understood that the portable ashtray system 12, as illustrated herein, is merely one example of a portable ashtray system. In this regard, the various teachings of the present disclosure can be used with any ashtray system, fixed or portable, having any desired shape or size to determine a concentration level of fine particulate matter and to communicate the concentration level to an associated display or electronic device.

Generally, the vehicle 10 includes a powertrain 14 for propulsion. The powertrain 14 includes a propulsion device, such as an internal combustion engine, fuel cell, electric motor, a hybrid-electric motor, etc., which supplies power to a transmission 16. The transmission 16 transfers this power to a suitable driveline coupled to one or more wheels (and tires) of the vehicle 10 to enable the vehicle 10 to move. The vehicle 10 also generally includes a frame, with a body 20 coupled to the frame to define a passenger compartment or cabin 22. The passenger cabin 22 provides various seating surfaces for one or more occupants of the vehicle 10, and generally includes one or more receptacles 24, such as a cup-holder 24a. In one embodiment, the ashtray system 12 is positionable within the cup-holder 24a, and is removably coupled to the cup-holder 24a to enable the ashtray system 12 to be moved by a user or occupant of the vehicle 10. Although the figures shown herein depict an example with certain arrangements of elements, additional intervening elements, devices, features, or components may be present in an actual embodiment. It should also be understood that FIG. 1 is merely illustrative and may not be drawn to scale. It should be noted that the ashtray system 12 can be used with any suitable vehicle, such as an aircraft, ship, train, automobile, etc. Moreover, it will be understood that the use of the ashtray system 12 with the vehicle 10 is merely an example. In this regard, the ashtray system 12 can be used separate and discrete from the vehicle 10, and can comprise a portable ashtray system 12 for one or more users. Moreover, the position of the one or more receptacles 24 is merely exemplary.

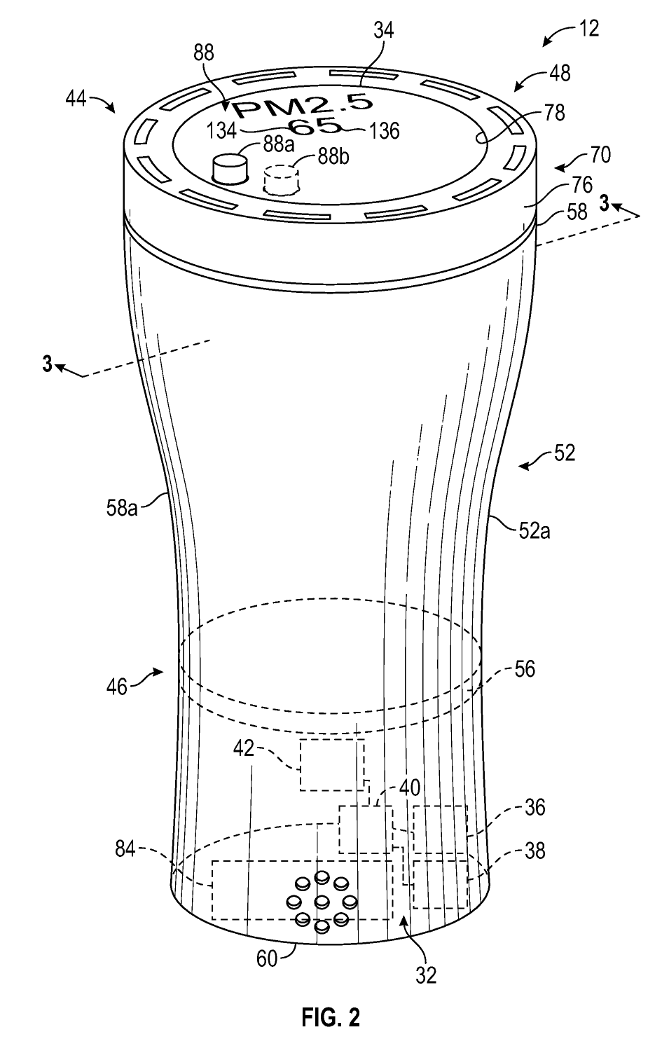

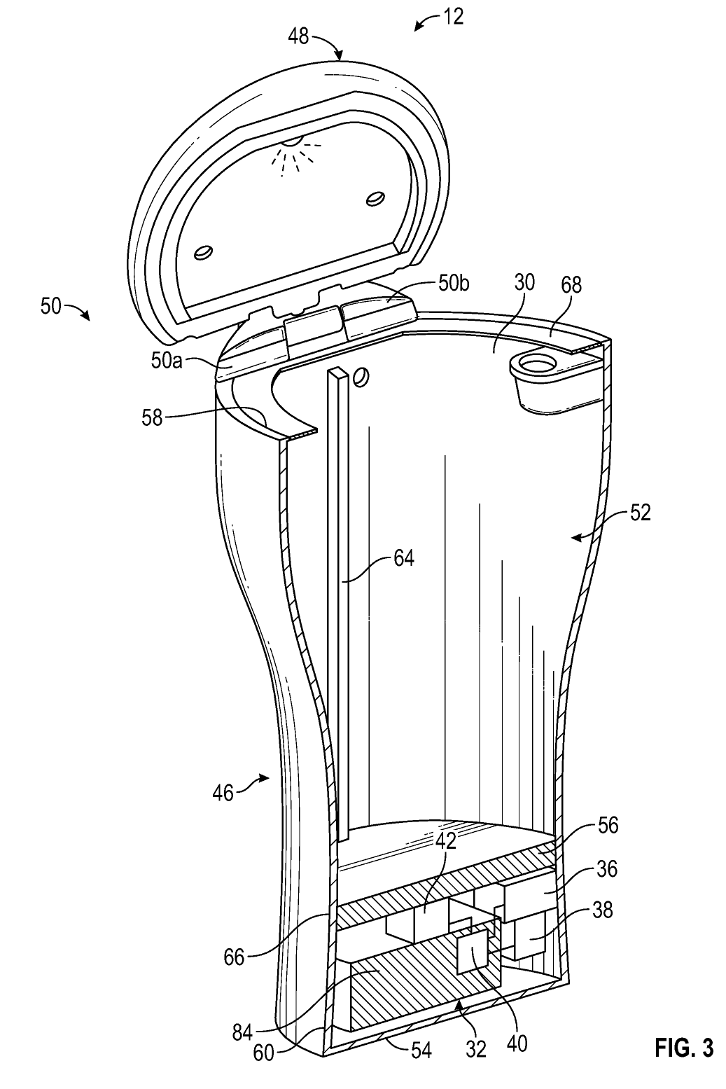

In one example, with reference to FIGS. 2 and 3, the ashtray system 12 includes a receptacle 30, a fine dust sensor system 32, a user interface 34, a communication component 36, a power source 38 and a control module 40. Optionally, the ashtray system 12 includes an ionizer 42. Each of the receptacle 30, the fine dust sensor system 32, the user interface 34, the communication component 36, the power source 38, the control module 40 and the ionizer 42 are coupled to a housing 44.

In one example, the housing 44 includes a first portion or a canister 46 and second portion or a lid 48. It should be noted that the housing 44 illustrated and described herein is merely exemplary, as the housing 44 can have any desired configuration. Generally, at least a portion of the lid 48 is movable relative to the canister 46 via at least one hinge 50 to provide access to the receptacle 30; however the lid 48 may be coupled to the canister 46 via any suitable technique including, but not limited to, a snap-fit, a living hinge, etc. In this example, the canister 46 and the lid 48 are composed of a heat resistant polymer, however, it will be understood that the canister 46 and/or the lid 48 may be composed of a suitable metal or metal alloy. The canister 46 and the lid 48 may be formed through any suitable technique, such as molding, 3D printing, etc. The canister 46 is generally cylindrical so as to be cup-shaped; however, the canister 46 can have any desired polygonal shape, such rectangular, trapezoidal, etc. Moreover, while the canister 46 is illustrated herein as comprising a single receptacle 30, the canister 46 can have multiple receptacles. Thus, the shape of the canister 46 is merely exemplary, and the shape of the canister 46 is not limited to that shown in the drawings. The canister 46 is generally sized to define the receptacle 30, and to receive the fine dust sensor system 32, the communication component 36, the power source 38 the control module 40 and the optional ionizer 42.

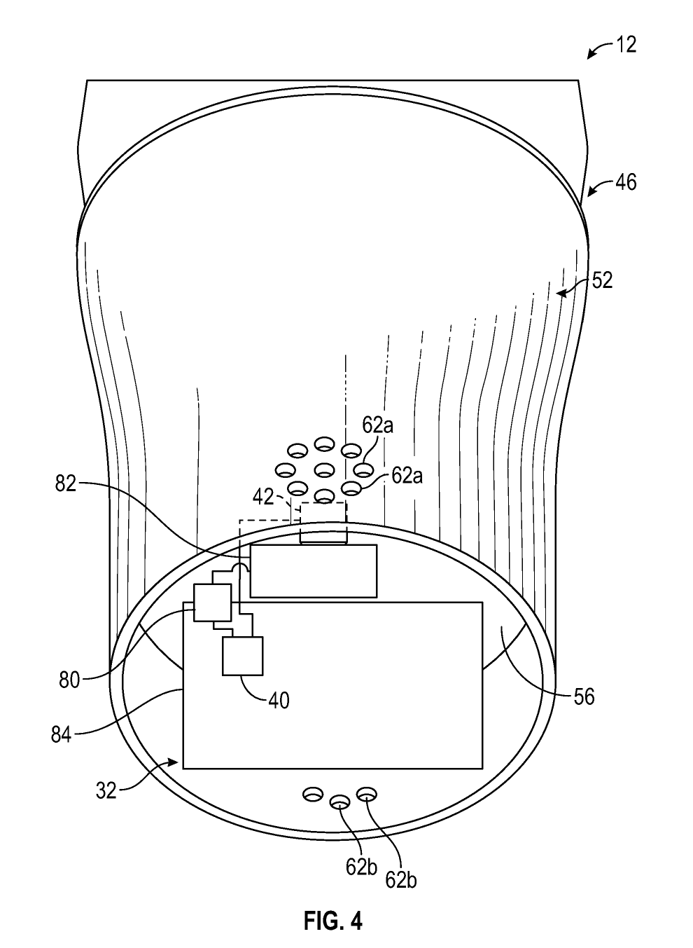

With reference to FIG. 3, the canister 46 is defined by an annular sidewall 52, and includes a base 54 and a divider 56. The annular sidewall 52 defines the shape of the canister 46, and with brief reference to FIG. 2, may include a taper 52a from an area 58a adjacent to a first end 58 of the canister 46 to a second end 60 of the canister 46. The taper 52a facilitates the positioning of the canister 46 within the cup-holder 24a (FIG. 1), and also forms a graspable surface for a user. The sidewall 52 may also include one or more airflow passages 62, as shown in FIG. 4. The airflow passages 62 facilitate airflow about the fine dust sensor system 32 to enable a particulate matter reading. In one example, the airflow passages 62 are defined near the second end 60, and include inlet airflow passages 62a and outlet airflow passages 62b. Thus, the airflow passages 62 define an air flow path through the canister 46 that enables air from the environment surrounding the canister 46, such as air within the passenger cabin 22 (FIG. 1), to be observed by the fine dust sensor system 32. With reference to FIG. 3, the annular sidewall 52 may also include a conduit 64, which extends between the first end 58 and the second end 60. The conduit 64 receives one or more wires to enable data transfer between the control module 40 and the user interface 34 (FIG. 2).

With reference to FIG. 3, the base 54 extends along the second end 60. The base 54 is generally planar, and circumferentially closes the second end 60 of the canister 46. In one example, the base 54 is integrally formed with the canister 46; however, the base 54 may be removable for servicing the fine dust sensor system 32. The divider 56 extends substantially parallel to the base 54, and is spaced apart from the base 54. The divider 56 circumferentially closes a portion of the canister 46 between the first end 58 and the second end 60 to define the receptacle 30 and to define a cavity 66. The divider 56 may be coupled to the canister 46 through a suitable post processing step, including, but not limited to, ultrasonic welding, etc. The cavity 66 is generally defined near the second end 60 such that the cavity 66 is in fluid communication with the airflow passages 62. The fine dust sensor system 32, the communication component 36, the power source 38, the control module 40 and the ionizer 42 are each received within the cavity 66.

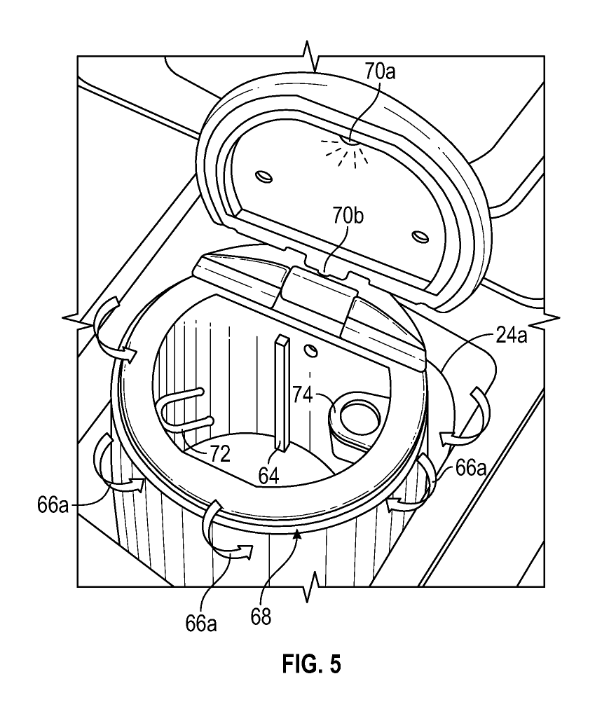

With reference back to FIG. 2, the lid 48 is coupled to the first end 58. In one example, the lid 48 is annular; however, the lid 48 may have any desired shape. The lid 48 encloses the receptacle 30, and in one example, the lid 48 includes a sealing flange 68 and a movable member 70. The sealing flange 68 is coupled to the first end 58 of the canister 46, and forms a portion 50a of the hinge 50. With reference to FIG. 5, the sealing flange 68 includes a U-shaped holder 72 and a circular tab 74, which may be used to support a smoking article, such as a cigarette. The sealing flange 68 is generally composed of metal or metal alloy, and is coupled to the first end 58 via a suitable fastening technique, such as welding, press-fit, mechanical fasteners, etc.

With reference back to FIG. 2, the movable member 70 forms a portion 50b of the hinge 50, which cooperates with the portion 50a to enable the movable member 70 to move or pivot between a first, closed position (FIG. 2) and a second, opened position (FIG. 5) relative to the sealing flange 68, and thus, the canister 46. Generally, the movable member 70 is movable relative to the canister 46 to expose the receptacle 30. The movable member 70 includes a lip 76 and a cavity 78. The lip 76 provides a graspable surface for moving the movable member 70. The cavity 78 receives the user interface 34, and thus, the cavity 78 is generally in communication with the conduit 64. In one example, the cavity 78 comprises a circular recess defined in a top surface of the movable member 70; however, the cavity 78 may have any desired shape to receive the user interface 34. Furthermore, the user interface 34 may be coupled directly to the top surface of the movable member 70, if desired. In certain embodiments, with reference to FIG. 5, the movable member 70 also includes a light source 70a. The light source 70a is coupled to the control module 40, and is operable to illuminate the receptacle 30. The light source 70a comprises any suitable light emitting element, such as a light emitting diode (LED), etc. The movable member 70 can also include a switch 70b, which is closed when the movable member 70 is in the second, opened position to enable power or current to flow to the light source 70a and opened when the movable member 70 is in the first, closed position to prevent the flow of power or current to the light source 70a.

With reference to FIG. 3, the receptacle 30 is defined by the sidewall 52 of the canister 46 and extends from the first end 58 to the divider 56. Generally, the receptacle 30 has a size that enables the receipt of ashes from the smoking article; however, the receptacle can receive any object or article, as desired by the user.

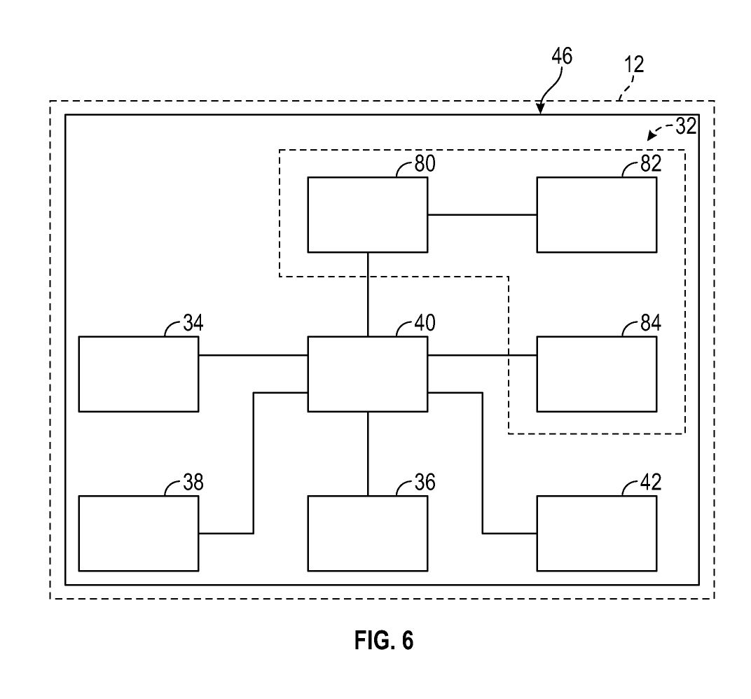

The fine dust sensor system 32 is received within the cavity 66. With reference to FIG. 6, the fine dust sensor system 32 includes a motor 80, a fan or blower 82 and a fine dust sensor 84. It should be noted that the motor 80, the fan or blower 82 and the fine dust sensor 84 can be implemented as a fine dust sensor unit, which is received in the cavity 66. The motor 80 comprises a small electric motor, such as a DC motor or other type of motor, which is responsive to one or more control signals from the control module 40. The motor 80 is in communication with the control module 40 over a communications architecture that facilitates the transfer of power, data, commands, etc. The motor 80 includes an output shaft (not shown), which is coupled to the blower 82. The blower 82 is generally coupled to the motor 80 and positioned within the cavity 66 such that the operation of the blower 82 draws air into the airflow passages 62. In one example, with reference to FIG. 4, the blower 82 is positioned adjacent to the inlet airflow passages 62a, and draws air into the cavity 66 to pass over the fine dust sensor 84 before the air exits the cavity 66 via the outlet airflow passages 62b. With reference back to FIG. 6, the blower 82 generally comprises one or more blades coupled to a rotor, which rotates upon receipt of torque from the motor 80 to direct or suck air into the cavity 66 via the inlet airflow passages 62a. With brief reference to FIG. 5, arrows 66a indicate the airflow into the cavity 66. Thus, upon receipt of the one or more control signals from the control module 40, the motor 80 drives the blower 82 via the output shaft (not shown) to draw air into the inlet airflow passages 62a for observation by the fine dust sensor 84.

The fine dust sensor 84 observes air that flows through the cavity 66 via the airflow passages 62 and generates sensor signals based thereon. In this example, the fine dust sensor 84 is an air quality sensor, which observes the air that flows through the cavity 66 and determines a quantity of fine dust or fine particulate matter contained within the airflow. For example, the fine dust sensor 84 can be a PM 2.5 sensor, which determines a concentration of fine particulate matter less than 2.5 micrometers in size that exist in the airflow (PM 2.5). In one example, the fine dust sensor 84 determines a concentration level of PM 2.5 in the airflow through the cavity 66 using a laser scattering theory. In certain embodiments, the fine dust sensor 84 determines a concentration level of PM 2.5 in the airflow through the cavity 66 using an infrared emitting diode (IRED) and a phototransistor. The sensor signals from the fine dust sensor 84 are communicated to the control module 40 over a suitable communications architecture that facilitates the transfer of power, data, commands, etc.

With reference to FIG. 2, the user interface 34 is communicatively coupled to the control module 40. In this example, the user interface 34 is coupled to the control module 40 via one or more wires that extend through the conduit 64 and enable the transfer of data, commands and power between the control module 40 and the user interface 34. It should be understood, however, that the user interface 34 can be wirelessly in communication with the control module 40. The user interface 34 includes a display 86, and includes at least one input device 88. The display 86 generally comprises a flat panel display, which is coupled to the cavity 78 of the movable member 70. The display 86 comprises any suitable technology for displaying information, including, but not limited to, a liquid crystal display (LCD), organic light emitting diode (OLED), plasma, or a cathode ray tube (CRT). Generally, the display 86 displays the level or concentration of the PM 2.5 in micrograms per cubic meter of air (μg/m³), as will be discussed in greater detail herein. It should be noted that the PM 2.5 concentration level may be displayed in any desired unit, and thus, the use of micrograms per cubic meter of air is merely exemplary. In various embodiments, the at least one input device 88 comprises a first input device 88a and an optional second input device 88b. In one example, the first input device 88a and second input device 88b each comprises a button, such as a push button, which is coupled to the movable member 70 and in communication with the control module 40. For example, the first input device 88a is operable by a user to send a command requesting a level of the PM 2.5 concentration in the air surrounding the ashtray system 12. The optional second input device 88b is operable by a user to send a command requesting an activation or deactivation of the ionizer 42. It should be noted that the at least one input device 88 may comprise any device to receive input and/or commands from the user, and the at least one input device 88 can comprise a touchscreen layer associated with the display 86.

With reference to FIG. 3, in certain embodiments, the communication component 36 communicatively couples the ashtray system 12 with a remote system, such as a system associated with the vehicle 10. In one example, the communication component 36 is communicatively coupled to a human-machine interface or infotainment system 10a of the vehicle 10 to transmit the PM 2.5 concentration level for the display of the PM 2.5 concentration level on the infotainment system 10a (FIG. 1). In another example, the communication component 36 is communicatively coupled to a climate control or HVAC system 10b associated with the vehicle 10, to enable control of the HVAC system 10b based on the observed PM 2.5 concentration level (FIG. 1). It should be noted, that the communication component 36 can also communicatively couple the ashtray system 12 to other remote systems and devices, such as portable electronic devices, including, but not limited to, mobile cellular phones, tablets, etc.

The communication component 36 comprises any suitable system for receiving data from and transmitting data to remote systems, such as the systems 10a, 10b associated with the vehicle 10, and in certain examples, may comprise a one-way transmitter. In various embodiments, the communication component 36 includes a radio configured to transmit data by modulating a radio frequency (RF) signal to a remote station (not shown) as is well known to those skilled in the art. For example, the remote station (not shown) may be part of a cellular telephone network and the data may be transmitted according to the long-term evolution (LTE) standard. The communication component 36 may also receive data from the remote station (not shown) to achieve bi-directional communications. However, other techniques for transmitting and receiving data may alternately be utilized. In one example, the communication component 36 achieves bi-directional communications with the vehicle 10 over Bluetooth® or by utilizing a Wi-Fi standard, i.e., one or more of the 802.11 standards as defined by the Institute of Electrical and Electronics Engineers (“IEEE”), as is well known to those skilled in the art. Thus, the communication component 36 comprises a Bluetooth® transceiver, a radio transceiver, a cellular transceiver, an LTE transceiver and/or a Wi-Fi transceiver. The communication component 36 may also be configured to encode data or generate encoded data. The encoded data generated by the communication component 36 may be encrypted. A security key may be utilized to decrypt and decode the encoded data, as is appreciated by those skilled in the art. The security key may be a “password” or other arrangement of data that permits the encoded data to be decrypted.

It will be understood that other configurations may also be possible. For example, in certain embodiments, the ashtray system 12 is communicatively coupled directly to the vehicle 10 via a docking station (not shown) disposed within the passenger cabin 22 (FIG. 1). The docking station may be in wired or wireless communication with the vehicle 10 to enable the ashtray system 12 to directly transmit data to the vehicle 10. The docking station may comprise a suitable interface, such as USB, microUSB, Apple® Lightning™, etc. that cooperates with an interface associated with the ashtray system 12 to enable data transfer from the ashtray system 12 to the vehicle 10. Moreover, the ashtray system 12 may be in wired communication with the vehicle 10, over a suitable cable interconnection, including, but not limited to USB, microUSB, etc., that facilitates the transfer of power, data, commands, etc. between the ashtray system 12 and the system of the vehicle 10. Thus, the communication component may comprise one or more ports that enable wired communication with a system of the vehicle 10. Further, it will be understood that the communication component 36 is not limited to enabling communication between the ashtray system 12 and the vehicle 10. Rather, the communication component 36 also enables the ashtray system 12 to communication with other electronic devices, such as portable electronic devices, including, but not limited to, tablets, cellular phones, etc.

The power source 38 supplies power to the various components of the ashtray system 12. In one example, the power source 38 supplies power to the control module 40, which in turn supplies power to the user interface 34, the communication component 36, the motor 80, the fine dust sensor 84 and the ionizer 42 over an architecture that facilitates the transfer of power from the power source 38 to the user interface 34, the communication component 36, the motor 80, the fine dust sensor 84 and the ionizer 42. The power source 38 generally comprises an integrated battery coupled within the cavity 66. In certain embodiments, however, the power source 38 comprises one or more solar panels coupled to the movable member 70 and/or the canister 46. As a further alternative, power may be supplied to the ashtray system 12 via a battery associated with the vehicle 10 through a wired connection. It should be understood, however, that any power source can be employed to provide power to the user interface 34, the communication component 36, the motor 80, the fine dust sensor 84 and the ionizer 42, including, but not limited to, the examples described herein above.

The ionizer 42 is disposed within the cavity 66. The ionizer is in communication with the control module 40 over a suitable architecture that facilitates the transfer of data, power, commands, etc. The ionizer 42 is responsive to one or more control signals from the control module 40 to electrically charge the air particles flowing through the cavity 66 to purify the airflow prior to the air exiting the cavity 66 through the outlet airflow passages 62b.

In various embodiments, the control module 40 outputs one or more control signals to the motor 80 to drive the blower 82 for the fine dust sensor system 32 to observe an airflow based on the systems and methods of the present disclosure. The control module 40 outputs an interface for display on the display 86 based on the sensor signals and the systems and methods of the present disclosure. The control module 40 outputs concentration data, indicating the PM 2.5 concentration level, to the vehicle 10, based on the sensor signals, and further based on the systems and methods of the present disclosure. In various embodiments, the control module 40 outputs one or more control signals to the ionizer 42 based on the input from the at least one input device 88, and further based on the systems and methods of the present disclosure.

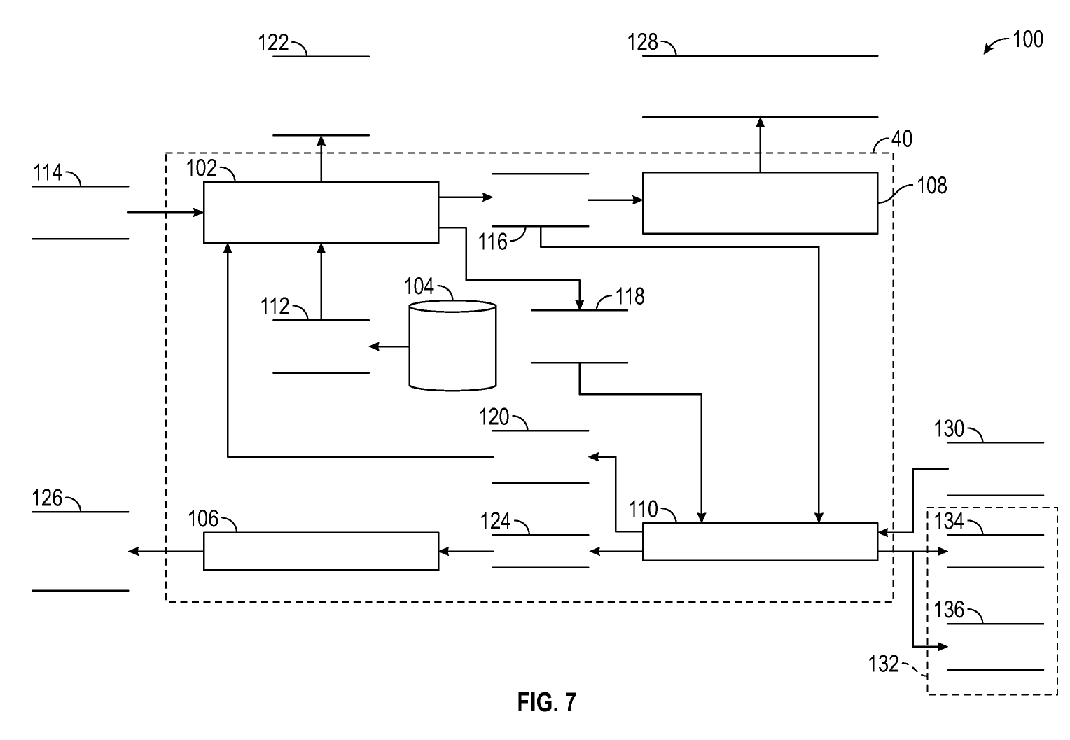

Referring now to FIG. 7, and with continued reference to FIGS. 2 and 3, a dataflow diagram illustrates various embodiments of a control system 100 for the ashtray system 12, which may be embedded within the control module 40. Various embodiments of the control system 100 according to the present disclosure can include any number of sub-modules embedded within the control module 40. As can be appreciated, the sub-modules shown in FIG. 7 can be combined and/or further partitioned to similarly control the motor 80, the ionizer 42, to transmit data to the vehicle 10 and to output the interface for display on the display 86. Inputs to the control system 100 may be received from the fine dust sensor 84 (FIG. 3), received from the at least one input device 88 of the user interface 34 (FIG. 2), received from other control modules (not shown) associated with the vehicle 10, and/or determined/modeled by other sub-modules (not shown) within the control module 40. In various embodiments, the control module 40 includes a level determination module 102, a quality datastore 104, an ionizer control module 106, a communication control module 108 and a user interface (UI) control module 110.

The quality datastore 104 stores one or more tables (e.g., lookup tables) that indicate an air quality based on a PM 2.5 concentration level observed by the fine dust sensor 84. In other words, the quality datastore 104 stores one or more tables that provide a quality value 112 for air surrounding the ashtray system 12 based on various PM 2.5 concentration levels. In various embodiments, the tables may be interpolation tables that are defined by one or more indexes. A quality value 112 provided by at least one of the tables indicates an air quality for the air surrounding the ashtray system 12 based on the PM 2.5 concentration level. An example quality value 112 can comprise an air quality rating, such as good (PM 2.5 concentration of about 0-35 μg/m³); moderate (PM 2.5 concentration of about 36-115 μg/m³); and poor (PM 2.5 concentration of greater than about 116-150 μg/m³). It should be noted that these air quality ratings are merely exemplary. As an example, one or more tables can be indexed by various parameters such as, but not limited to, PM 2.5 concentration level, to provide the quality value 112.

The level determination module 102 receives as input sensor data 114. The sensor data 114 comprises the sensor signals from the fine dust sensor 84. The level determination module 102 processes the sensor data 114 and determines a concentration level 116. The level determination module 102 sets the concentration level 116 for the communications control module 108 and the UI control module 110. The concentration level 116 comprises the PM 2.5 concentration level as observed by the fine dust sensor 84.

Based on the receipt of the sensor data 114, the level determination module 102 queries the quality datastore 104 and retrieves the quality value 112 associated with the PM 2.5 concentration level observed and measured by the fine dust sensor 84. Based on the retrieved quality value 112, the level determination module 102 sets air quality data 118 for the UI control module 110. In one example, the air quality data 118 comprises one of good, moderate or poor.

The level determination module 102 receives as input a level command 120 from the UI control module 110. The level command 120 comprises a request for a determination of the PM 2.5 concentration level in the air surrounding the ashtray system 12, as received from the at least one input device 88, for example, the input device 88a. Based on the level command 120, the level determination module 102 outputs sensor control data 122. The sensor control data 122 comprises one or more control signals for the motor 80, which drives the blower 82 to draw air into the inlet airflow passages 62a to be observed by the fine dust sensor 84 for the generation of sensor signals. In various embodiments, the level determination module 102 outputs the sensor control data 122 based on the receipt of the level command 120 from the UI control module 110. In certain embodiments, the level determination module 102 can output the sensor control data 122 substantially continuously such that the PM 2.5 concentration level is substantially continuously observed and measured by the fine dust sensor 84. As a further alternative, the level determination module 102 can output the sensor control data 122 at periodic intervals upon receipt of a first level command 120 from the UI control module 110, such that the PM 2.5 concentration level is observed and measured periodically at specified time intervals.

The ionizer control module 106 receives as input a command 124 from the UI control module 110. The command 124 comprises a request to activate or deactivate the ionizer 42, as received from the at least one input device 88, such as the input device 88b. The ionizer control module 106 processes the command 124 and determines a current state of the ionizer 42 as activated (e.g. ON and running) or deactivated (e.g. OFF). Based on the command 124 and the current state of the ionizer 42, the ionizer control module 106 outputs ionizer control data 126. The ionizer control data 126 comprises one or more control signals to the ionizer 42 to activate the ionizer 42 if the ionizer 42 is deactivated or one or more control signals to deactivate the ionizer 42 if the ionizer 42 is activated.

The communication control module 108 receives as input the concentration level 116 from the level determination module 102. The communication control module 108 processes the concentration level 116 and outputs concentration level data 128 for transmission by the communication component 36. The concentration level data 128 comprises the PM 2.5 concentration level, as observed and measured by the fine dust sensor 84.

The UI control module 110 receives user input 130. The user input 130 comprises input received to the at least one input device 88, for example, the input device 88a and the input device 88b. The UI control module 110 processes the user input 130 and sets the level command 120 for the level determination module 102 based on input received from the user input device 88a. The UI control module 110 may also process the user input 130 and set the command 124 for the ionizer control module 106 based on input received from input device 88b.

The UI control module 110 also receives as input the concentration level 116 and the air quality data 118. The UI control module 110 processes the concentration level 116 and the air quality data 118, and generates user interface data 132. The user interface data 132 includes a concentration 134 for display on the display 86 and a quality level indicator 136 for display on the display 86. The concentration 134 comprises a textual indication of the PM 2.5 concentration level, as indicated by the concentration level 116. For example, the concentration 134 comprises the text: “PM 2.5 X,” and X comprises the PM 2.5 concentration level from the concentration level 116. The quality level indicator 136 comprises a graphical indicator of the air quality surrounding the ashtray system 12, as indicated by the air quality data 118. In one example, the quality level indicator 136 comprises a color associated with the text of the concentration 134. For example, based on the air quality data 118 of good, the quality level indicator 136 comprises a green color, and the concentration 134 text is illustrated in green. In this example, the quality level indicator 136 for the air quality data 118 of moderate comprises a yellow color, and the quality level indicator 136 for the air quality data 118 of poor comprises a red color. Thus, the user interface data 132 can include both a textual and/or numerical indicator of the PM 2.5 concentration level along with a visual indicator of the air quality level via the quality level indicator 136.

It will be understood that the textual and/or numerical indicator of the PM 2.5 concentration level and the air quality level can be implemented in various ways. For example, the user interface data 132 can comprise a first display mode, in which the user interface data 132 includes the concentration 134, with the text “PM 2.5 X” output in a color determined based on the air quality data 118. The user interface data 132 can also comprise a second display mode, in which the text “PM 2.5” is in a first, default color and a value of the concentration level 116 is output in a second, different color based on the air quality data 118. For example, the text of the value of the concentration level 116 or the X in the concentration 134 would be a particular color based on the air quality data 118. Thus, the numeric value for the concentration level 116 can be displayed in a particular color based on the air quality data 118, including, but not limited to, green, yellow or red, as discussed previously herein. As a further example, the user interface data 132 can comprise a third display mode, in which the concentration 134 is output, with the text: “PM 2.5 X,” in a single, default color, including, but not limited to, black. Moreover, it should be noted that these examples of the quality level indicator 136 are merely exemplary, as the quality level indicator 136 for the air quality data 118 of good may comprise a graphical icon, such as a smiling emoticon.

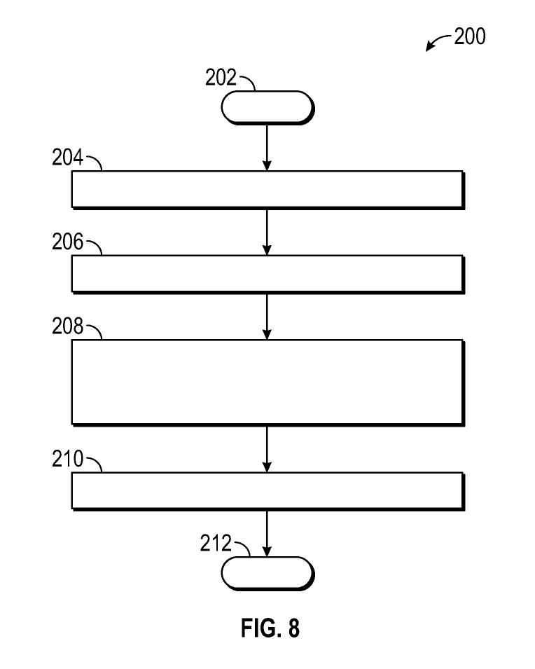

Referring now to FIG. 8, and with continued reference to FIGS. 1-7, a flowchart illustrates a control method 200 that can be performed by the control module 40 of FIGS. 1-7 in accordance with the present disclosure. As can be appreciated in light of the disclosure, the order of operation within the method is not limited to the sequential execution as illustrated in FIG. 7, but may be performed in one or more varying orders as applicable and in accordance with the present disclosure.

In various embodiments, the method can be scheduled to run periodically or based on predetermined events, and for example, can run based on the receipt of user input data 130, such as input data received via the at least one input device 88.

In one example, the method begins at 202. At 204, the method actuates the motor 80, thereby actuating the blower 82, to draw air into the cavity 66. At 206, the method determines the PM 2.5 concentration level in the air based on the sensor signals from the fine dust sensor 84. At 208, based on the determined PM 2.5 concentration level, the method determines the air quality level and outputs the user interface 132, which includes the concentration 134 and the quality level indicator 136. At 210, the method transmits, via the communication component 36, the PM 2.5 concentration level to the remote system, such as the infotainment system 10a or the HVAC system 10b associated with the vehicle 10. The method ends at 212.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for determining a particulate concentration level with a portable component, the method comprising:
outputting one or more control signals, by a processor, to activate a motor to generate an airflow stream through a cavity of the portable component;
determining a concentration level of fine particulate matter in the airflow;
determining an air quality level of the airstream through the cavity based on the determined concentration level; and
outputting the determined concentration level with a graphical indicator of the air quality level for display on a display associated with the portable component.

2. The method of claim 1, wherein the portable component comprises a portable ashtray.

3. The method of claim 1, further comprising:
transmitting the determined concentration level to a remote system.

4. The method of claim 3, wherein transmitting the determined concentration level to the remote system further comprises:
transmitting the determined concentration level to a remote system associated with a vehicle.

5. The method of claim 1, further comprising:
receiving an input; and
outputting the one or more control signals based on the input.

6. A portable component for determining a fine particulate matter concentration level, comprising:
a housing that defines a cavity, the housing having at least one inlet airflow passage and at least one outlet airflow passage in fluid communication with the cavity;
a display coupled to the housing;
a source of an airflow through the cavity;
a fine particulate matter sensor that observes the airflow through the cavity and generates sensor signals based thereon; and
a control module that processes the sensor signals and determines the fine particulate matter concentration level, determines an air quality level based on the fine particulate matter concentration level and outputs the fine particulate matter concentration and an indicator of the air quality level for display on the display.

7. The portable component of claim 6, wherein the portable component is a portable ashtray.

8. The portable component of claim 6, wherein the housing includes a canister and a lid coupled to the canister, the canister defines the cavity and a receptacle, with at least a portion of the lid movable to expose the receptacle and the display is coupled to the lid.

9. The portable component of claim 6, further comprising a communication component that transmits the particulate matter concentration level to a remote system.

10. The portable component of claim 9, wherein the remote system is a system associated with a vehicle.

11. The portable component of claim 6, further comprising:
an ionizer disposed within the cavity and in communication with the control module;
a source of input that comprises a command for the ionizer; and
wherein the control module processes the command and outputs one or more control signals to the ionizer to activate or deactivate the ionizer.

12. The portable component of claim 6, wherein the source of the airflow is a blower, the blower is coupled to a motor, and the motor and the blower are received within the cavity.

13. The portable component of claim 12, wherein the motor is responsive to one or more control signals from the control module to drive the blower and generate the airflow.

14. A portable ashtray for determining a fine particulate matter concentration level, comprising:
a housing having a first portion that defines a cavity and an ash receptacle, and a second portion, at least a portion of the second portion movable relative to the first portion to expose the ash receptacle, the first portion defining at least one inlet airflow passage and at least one outlet airflow passage in fluid communication with the cavity;
a source of an airflow through the cavity;
a fine particulate matter sensor disposed in the cavity that observes the airflow through the cavity and generates sensor signals based thereon;
a display coupled to the second portion; and
a control module that processes the sensor signals and determines the fine particulate matter concentration level, determines an air quality level based on the fine particulate matter concentration level and outputs the fine particulate matter concentration and an indicator of the air quality level for display on the display.

15. The ashtray of claim 14, further comprising a communication component that transmits the particulate matter concentration level to a remote system associated with a vehicle.

16. The ashtray of claim 15, wherein the controller outputs a value of the fine particulate matter concentration for display on the display and the indicator of the air quality level for display on the display is a color of the value.

17. The ashtray of claim 14, further comprising:
an ionizer disposed within the cavity and in communication with the control module;
a source of input that comprises a command for the ionizer; and
wherein the control module processes the command and outputs one or more control signals to the ionizer to activate or deactivate the ionizer.

18. The ashtray of claim 14, wherein the source of the airflow is a blower, the blower is coupled to a motor, and the motor and the blower are received within the cavity.

19. The ashtray of claim 18, wherein the motor is responsive to one or more control signals from the control module to drive the blower and generate the airflow.

20. The ashtray of claim 14, further comprising a power source disposed in the cavity and in communication with the control module.
